(19) United States
(12) Patent Application Publication
(10) Pub. No.: US 2025/0178059 A1
(43) Pub. Date: Jun. 5, 2025

(54) MOLDED COMPONENT AND METHOD FOR PRODUCING A MOLDED COMPONENT

(71) Applicant: BENTELER AUTOMOBILTECHNIK GMBH, Paderborn (DE)

(72) Inventors: Karl-Heinz MUELLER, Lippstadt (DE); Peter STASTNY, Delbrueck (DE)

(21) Appl. No.: 18/963,504

(22) Filed: Nov. 28, 2024

(30) Foreign Application Priority Data
Dec. 1, 2023 (DE) 102023133730.0

(51) Int. Cl. B21D 22/02; B21D 53/00

(52) U.S. Cl. CPC B21D 22/022; B21D 53/00

(57) ABSTRACT

A molded component has a metallic component body with a mounting opening and a friction structure surrounding the mounting opening. The component body consists of a boron-alloyed steel and is hot molded and press hardened. The friction structure is produced in the press tool during hot molding. In order to produce the component body, a hardenable steel sheet metal or a semi-finished product made of a hardenable steel sheet metal is heated to the molding temperature and molded into the component body in a press tool and press hardened. The mounting opening can be produced before heating to the molding temperature, before hot molding or after press hardening.

The invention relates to a molded component and to a method for producing a molded component.

Molded components with a metallic component body, which are connected within a connection arrangement to a further molded component or a mounting element, are used in a wide variety of commercial and industrial applications.

Particularly in motor vehicle construction, molded components made of metal or steel sheet metal are used, for example in the form of body components or structural components. The molded components are frequently connected to further molded components and/or add-on components and assembled to form an assembly or a motor vehicle component.

The connection of the molded components and components typically takes place via screw connections. In this case, screws are guided into or through mounting openings and clamped in abutment. Application-specific, this is done with the integration of washers. Enclosed between the screw head and the component body to be fastened with the screw, a washer serves to distribute and transmit the force emanating from the underside of the screw head to a larger region of the component body. In the case of pass-through screws, depending on the application, a washer is also provided under the locking nut.

Motor vehicle components are subject to strong static and dynamic loads during operation. A high quality of the motor vehicle components themselves as well as their mounting and, in particular, of the connection points of or between the molded components is therefore indispensable, in particular when it is a question of chassis or body components. In the case of motor vehicle components connected by screwing, a good and slip-proof connection of the components to other connection points is mandatory.

Conventional separate washers do not provide the best conditions for this. Their assembly is also complicated.

There are also proposals to dispense with washers and to profile the surface of at least one component in the region of the clamping surface of a press connection.

DE 10 2012 022 504 A1 discloses a press connection of two components. The components have connection surfaces which rest against one another and are connected to one another by pressing, at least one connection surface of which is provided with a surface structure for increasing a coefficient of friction. The surface structure is produced and hardened by means of a laser process or by means of an embossing or cold-pressing process. The hardening can be carried out inductively or by laser or electron beam processes.

DE 10 2007 016 643 A1 adds a form-fitting clamping connection and a method for producing the same to the prior art. The frictional clamping connection comprises a first metallic clamping surface, a second metallic clamping surface and a clamping member for clamping the clamping surfaces against each other. The first clamping surface forms a hardened surface fine structure with microelevations and depressions and is preferably surface-treated by sandblasting, shot peening or embossing before hardening.

Known embodiments of connection points with mechanically produced surface structures in the connection or clamping region between joining partners have proven themselves in practice and are well suited for various applications. However, there is also potential for improvement here both in the functionality of the connection points and in the rationality of the molded components and of the connection arrangements with such molded components. There is also a general desire to design the molded components, including their connection points, in an effective lightweight construction.

Starting from the prior art, the object of the invention is to improve the production and functional characteristics of a molded component having a metallic component body and a friction structure and to provide a rational and advantageous method for producing molded components.

The solution to the physical part of the problem consists of a molded component according to claim 1.

The method part of the object is achieved with a method for producing a molded component according to claim 5.

Embodiments and modifications of features of the molded component as well as of method steps which, individually or in combination, design or refine the invention in a technically advantageous manner can also be found in the description and the accompanying drawings.

The molded component according to the invention has a metallic component body with a mounting opening and a friction structure surrounding the mounting opening. The friction structure is embossed and hardened.

According to the invention, the component body consists of a hardenable steel and is hot molded and press-hardened, the friction structure being produced during hot molding of the component body. This takes place by embossing friction elements in the press tool, wherein friction elements are embossed into the surface of the component body.

The embossing of the friction structure in the press tool takes place on the steel sheet metal heated to the hot molding temperature in the press tool by material displacement, so that the friction structure has elevations and/or depressions. The component body and the friction structure produced on the component body are clamped in the cooled press tool and hardened by cooling.

The molded component or its metallic component body consists of a hardenable steel. The friction structure is produced in one piece on the component body with the same material. This is done by embossing in the press tool during molding and mold hardening of the component body.

In particular, the hardenable steel is a boron-alloyed steel, preferably a manganese-boron steel, for example 22MnB5.

The friction elements have a height. The height is measured from the outer surface of the component body to the outer tip of the friction structure or a friction element of the friction structure. Individual friction elements can have a height of 0.05 mm to 0.9 mm, in particular 0.1 mm to 0.4 mm. The average height is the arithmetic mean, i.e. the average value of the height of the friction elements of a friction structure.

A component body of a molded component has a wall thickness of between 1.0 mm and 3.5 mm inclusive.

An embodiment which is advantageous according to the invention provides that the ratio of the average height of the friction elements to the wall thickness of a component body is between 1:4 and 1:70. In particular, the ratio is 1:10 to 1:35.

The friction elements can be configured in the form of ribs, waves, points or balls. The friction elements can completely or partially surround the mounting opening.

Friction elements in the form of ribs which extend radially outwards from a mounting opening are particularly advantageous. The ribs have an average height, measured over their length, of 0.05 to 0.9 mm, in particular 0.1 to 0.4 mm.

The friction structure is designed and intended to increase the friction between the joining partners or the clamping surfaces within a connection arrangement. The spatial design and the arrangement of the friction elements within the friction structure is matched to the connection point within a connection arrangement.

The friction structure can have ribs produced by embossing, which have an annular profile. In this case, the annular friction elements can be arranged concentrically around the mounting opening.

Particularly advantageously, the friction structure has friction elements produced by embossing in the form of ribs which extend radially outwards from the mounting opening. In particular, the ribs extend in the radial direction, i.e. they have a radial course in the form of rays with respect to the center of a mounting opening. The ribs are elevations with respect to the regions adjacent to the ribs. The ribs provide the necessary friction and are subject to high loads when the molded component is clamped within a connection arrangement. In this context, the friction structure produced and press-hardened in the press tool proves to be advantageous.

A friction structure which is advantageous in practice has a hardness (Vickers hardness) of 350 HV to 550 HV, in particular 400 HV to 500 HV.

In order to produce a molded part according to the invention, a hardenable steel sheet metal or a semi-finished product made of a hardenable steel sheet metal, in particular a sheet metal made of a manganese-boron steel, is hot molded into a component body in a press tool and press-hardened. During hot molding in the press tool, a region of the steel sheet metal is provided with a friction structure. This is done in the press tool by embossing.

The region with the friction structure is embossed around a mounting opening.

The molded component is produced by mold hardening from an optionally premolded steel sheet. Mold hardening is also technically known as press hardening. During hot embossing, a sheet of manganese-boron steel is heated to a temperature above the specific austenitization temperature of the material, placed in a molding tool, and hot molded into the molded component, wherein it cools during forming. Clamped in the molding tool, the molded components are hardened by cooling.

In particular, the steel sheet metal or semi-finished product is heated to a temperature above 750° C. for hot molding, in particular to a temperature above the Ac3 temperature of the hardenable steel.

The mounting opening can be produced before the heating of the steel sheet metal or a semi-finished product produced from a hardenable steel sheet metal. Subsequently, the steel sheet/semi-finished product is heated to the molding temperature in a furnace installation, transferred to the pressing tool and hot molded and press-hardened, the region around the mounting opening being provided with the friction structure by embossing and the molded component body being press-hardened in the pressing tool.

It is also possible for the mounting opening to be produced on the heated steel sheet metal or semi-finished product before hot molding. This is preferably done before or during the transfer of the heated steel sheet metal/semi-finished product into the press tool.

Finally, it is also possible for the mounting opening to be produced after the component body has been press-hardened. This process can be carried out by laser cutting after removal of the press-hardened component body from the press tool.

A molded component according to the invention is in particular a motor vehicle component. A molded component can be used as a component of an axle, an axle component or an axle body, for example an auxiliary frame as well as an aggregate carrier.

A motor vehicle component can be produced in a steel construction, preferably from shell-shaped molded components which are connected to one another and of which at least one is designed according to the invention and has connection points with mounting openings. At least one mounting opening has a friction structure surrounding the mounting opening, which friction structure is produced during hot molding of the component body and is press-hardened with the component body in the press tool.

The invention advantageously integrates the production and hardening of the friction structure into the molding and hardening process of the component body. This is particularly effective and advantageous. The integration of the friction structure in the component body and the press hardening process also results in an optimization of the component weight. Additional washers or surface structures produced by means of material application are dispensed with. In this way, a contribution to the lightweight construction can be made.

For weight reduction, in particular in the area of battery-electric vehicles, parts of the shell structure are increasingly designed as hot molded parts which, by virtue of their higher strengths, make it possible to save material and thus weight. According to the invention, the friction structure is embossed into the component body during the hot molding process and hardened simultaneously with the component body by cooling in the press tool.

When the molded component is used within a connection arrangement, assembly or mounting takes place with further molded components and/or add-on components. This is done via screw connections. When assembling a molded component according to the invention with a, in particular softer, counterpart or joining partner, such as, for example, an axle carrier, the friction structure can dig into the counterpart or the second joining partner.

Within the scope of the invention, the process steps of hot molding and embossing a friction structure and their hardening are combined in one process step and in a press tool. Subsequent hardening of the friction structure is not necessary. The process achieves hardnesses in the range from 350 to 550 HV, in particular 400 HV to 500 HV. The friction structure preferably has a homogeneous hardness distribution which likewise uniformly merges into the region surrounding the friction structure. This avoids critical mechanical notches and, while ensuring a high degree of wear protection, avoids the risk of a crack or component breakage. Within the scope of the invention, a homogeneous hardness distribution within the friction structure is to be understood as meaning that the hardness therein preferably does not fluctuate by more than 100 HV, in particular by less than 50 HV. Likewise, the hardness of the friction structure does not differ by more than 100 HV from the hardness of surrounding regions.

The invention is described in the following with reference to an exemplary embodiment.

In the figures:

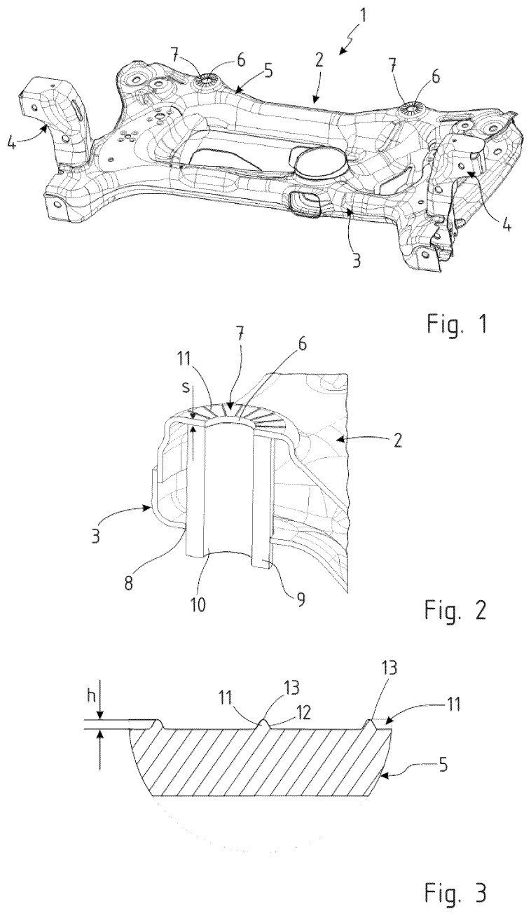

FIG. 1 shows a motor vehicle component in the form of a subframe in a perspective view;

FIG. 2 shows a section of the motor vehicle component with the representation of a connection point in the motor vehicle component, and

FIG. 3 shows a technical diagram of a section of a friction structure on the motor vehicle component.

FIG. 1 shows a perspective view of a motor vehicle component 1 in the form of a subframe.

The motor vehicle component 1 is produced in a sheet metal shell construction and has a first shell-shaped molded component 2 and a second shell-shaped molded component 3. Furthermore, the motor vehicle component 1 has lateral dome elements 4. The molded components 2 and 3 and the dome elements 4 are designed as sheet metal molded parts and are joined to form the motor vehicle component 1.

The first molded component 2 has a component body 5 with mounting openings 6 which are provided as connection points.

The mounting openings 6 in the component body 5 of the first molded component 2 are surrounded by a friction structure 7. The friction structure 7 has elevations and depressions. The friction structure 7 is produced by embossing in one piece with the same material on or in the component body 5. This takes place in the course of the hot molding production of the component body 5 in a press tool. In the press tool, the friction structure 7 is embossed during the hot molding process in a region of the component body 5 which surrounds a mounting opening 6. Clamped in the press tool, the component body 5 with the friction structure 7 is press-hardened in the press tool.

A section through the motor vehicle component 1 in the region of a connection point with a mounting opening 6 and a friction structure 7 is shown in FIG. 2.

The mounting opening 6 is provided in the component body 5 of the first shell-shaped molded component 2 and is surrounded by the friction structure 7 in a radially circumferential manner. The lower second molded component 3 has a mounting opening 8. A sleeve body 9 is arranged below the upper mounting opening 6 in the first molded component 2. The pass-through opening 10 of the sleeve body 9 communicates with the upper mounting opening 6. The sleeve body 9 passes through the lower mounting opening 8 and is joined in a material-locking manner both to the first molded component 2 and to the second molded component 3.

The friction structure 7 surrounds the mounting opening 6 in the component body 5 of the first molded component 2 in a completely annular or ring-shaped manner.

An enlarged section of a friction structure 7 is shown in FIG. 3.

The friction structure 7 has friction elements 11 in the form of ribs produced by embossing in the press tool during the molding of the component body 5. The ribs 11 extend outward from the mounting opening 6. The friction structure 7 has a plurality of straight ribs 11 which are arranged in the form of rays and extend from radially inwards to radially outwards with respect to the mounting opening 6. A rib 11 is triangular in cross-section and widens to its base. The straight flanks 12 of a rib 11 are at an angle to one another and open into a rib crest 13. The individual ribs 11 have a height h, measured over their length, of 0.1 to 0.4 mm, in particular of about 0.3 mm. An average height h of all friction elements 11 or ribs of a friction structure 7 is obtained from the arithmetic average of the individual values.

The component body 5 has a wall thickness s of 1.0 mm to 3.5 mm.

In order to produce the molded component 2, a sheet of boron-alloyed steel, in particular of a manganese-boron steel, or a semi-finished product premolded from the sheet metal is heated to a molding temperature above the specific austenitization temperature of the boron-alloyed steel material. The steel sheet metal or the semi-finished product is then inserted into a press tool and hot molded between an upper tool and a lower tool of the press tool to form the molded component. In this case, the friction structure 7 with the friction elements 11 is embossed in a region of the component body 5. During molding, the component body 5 is clamped in the press tool and the molded component is hardened by cooling.

The mounting opening 6 can be produced on the starting sheet steel plate, i.e. on the flat sheet steel of a hardenable steel or a semi-finished product produced from the hardenable sheet steel, before the sheet steel or the semi-finished product is heated to the molding temperature and is molded and press-hardened in the press tool.

The mounting opening 6 can also be produced after the steel sheet metal/semi-finished product has been heated to the molding temperature before the hot molding and press hardening takes place.

It is also possible for the mounting opening 6 to be produced after press-hardening on the press-hardened component body 5. For this purpose, the mounting opening 6 is made by laser cutting in the component provided with the friction structure 7 or the friction elements 11. The perforation is carried out in such a way that the mounting opening 6 is surrounded all around by the friction structure 7.

It goes without saying that the second shell-shaped molded component 3 can also be produced by mold or press hardening. Here, too, a friction structure 7 surrounding the mounting opening 8 can be produced and hardened by embossing in the press tool.

The friction structure 7 has a hardness, determined by the Vickers hardness test, of from 350 HV to 550 HV, in particular from 400 HV to 500 HV. Since the component body 5 and the friction structure 7 on the component body 5 are produced during the production of the molded component by mold or press hardening, the component body 5 of the molded component 2 also has a corresponding hardness in the range between 350 HV and 550 HV, in particular 400 HV to 500 HV.

The friction structure 7 increases the friction in the surface region surrounding a mounting opening 6, as a result of which screw elements used for mounting and the screw connection produced hold better and permanently. Even under heavy static and dynamic loads in the operational use of a motor vehicle.

### REFERENCE NUMERALS

1—motor vehicle component
2—first molded component
3—second molded component
4—dome element
5—component body
6—mounting opening
7—friction structure
8—mounting opening
9—sleeve body
10—pass-through opening
11—rib
12—flank
13—rib crest
h—average height of 11
s—wall thickness of 5

1-9. (canceled)

10. A molded component, which has a metallic component body with a mounting opening and a friction structure surrounding the mounting opening, wherein the friction structure is embossed and hardened, characterized in that the component body consists of a hardenable steel and is hot molded, wherein the friction structure is produced and the friction structure has friction elements produced by embossing and the component body is press-hardened.

11. The molded component according to claim 10, wherein the friction elements have an average height and the component body has a wall thickness, wherein the ratio between the average height of the friction elements and the wall thickness of the component body is between 1:4 and 1:70, in particular the ratio is 1:10 to 1:35.

12. The molded component according to claim 10, wherein the friction elements are configured in the form of ribs, waves, points or balls.

13. The molded component according to claim 10, wherein the friction structure has a hardness of 350 HV to 550 HV, in particular of 400 HV to 500 HV.

14. A method for producing a molded component, wherein a hardenable steel sheet metal or a semi-finished product of a hardenable steel sheet metal is heated to the molding temperature and hot molded in a press tool to form a component body and press-hardened, in that, during hot molding in the press tool, in a region of the steel sheet metal a friction structure with friction elements is provided by embossing.

15. The method according to claim 14, wherein the region having the friction structure is formed around a mounting opening.

16. The method according to claim 15, wherein the mounting opening is produced before hot molding.

17. The method according to claim 15, wherein the mounting opening is produced before the steel sheet metal is heated to molding temperature.

18. The method according to claim 15, wherein the mounting opening is produced after the component body has been press hardened.
